(19) United States
(12) Patent Application Publication
(10) Pub. No.: US 2026/0067814 A1
(43) Pub. Date: Mar. 5, 2026

(54) RESOLVING COLLISIONS WITH LOW-POWER WAKE-UP SIGNALS IN SUBBAND FULL-DUPLEX RESOURCES

(71) Applicant: QUALCOMM Incorporated, San Diego, CA (US)

(72) Inventors: Diana MAAMARI, San Diego, CA (US); Ahmed Attia ABOTABL, San Diego, CA (US); Huilin XU, Temecula, CA (US); Muhammad Sayed Khairy ABDELGHAFFAR, San Jose, CA (US); Abdelrahman Mohamed IBRAHIM, San Diego, CA (US)

(21) Appl. No.: 19/253,344

(22) Filed: Jun. 27, 2025

Related U.S. Application Data
(60) Provisional application No. 63/688,777, filed on Aug. 29, 2024.

(51) Int. Cl. H04W 52/02; H04L 5/14

(52) U.S. Cl. CPC H04W 52/0235; H04L 5/14; H04W 52/0274

(57) ABSTRACT

Methods, systems, and devices for wireless communications are described. Techniques described herein may enable a user equipment (UE) to identify prioritization rules for monitoring for low-power wake-up signals (LP-WUSs) or transmitting uplink messages in a subband full-duplex (SBFD) slot configured with both uplink and downlink resources. For example, the prioritization rules may instruct the UE to prioritize the LP-WUS over the uplink message or to prioritize the LP-WUS over the uplink message if the LP-WUS. In some examples, the prioritization rules may instruct the UE to both monitor for the LP-WUS via a low-power wake-up radio (LP-WUR) and transmit the uplink message with a main radio of the UE. In some examples, the UE may receive configuration information indicating the one or more prioritization rules.

### CROSS REFERENCE

The present application for patent claims the benefit of U.S. Provisional Patent Application No. 63/688,777 by MAAMARI et al., entitled “RESOLVING COLLISIONS WITH LOW-POWER WAKE-UP SIGNALS IN SUBBAND FULL-DUPLEX RESOURCES,” filed Aug. 29, 2024, assigned to the assignee hereof, and expressly incorporated by reference herein.

### FIELD OF TECHNOLOGY

The following relates to wireless communications, including resolving collisions with low-power wake-up signals (LP-WUSs) in subband full-duplex (SBFD) resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first configuration information that indicates a subband full-duplex (SBFD) resource that includes one or more uplink resources and one or more downlink resources that overlap in time with the one or more uplink resources, receiving second configuration information that schedules a low-power wake-up signal (LP-WUS) during the one or more downlink resources of the SBFD resource, receiving third configuration information that schedules an uplink transmission during the one or more uplink resources of the SBFD resource, and participating in communications with one or both of the LP-WUS and the uplink transmission during the SBFD resource in accordance with one or more prioritization rules.

A UE for wireless communications is described. The UE may include one or more memories storing processor executable code, and one or more processors coupled with the one or more memories. The one or more processors may individually or collectively be operable to execute the code to cause the UE to receive first configuration information that indicates a SBFD resource that includes one or more uplink resources and one or more downlink resources that overlap in time with the one or more uplink resources, receive second configuration information that schedules a LP-WUS during the one or more downlink resources of the SBFD resource, receive third configuration information that schedules an uplink transmission during the one or more uplink resources of the SBFD resource, and participate in communications with one or both of the LP-WUS and the uplink transmission during the SBFD resource in accordance with one or more prioritization rules.

Another UE for wireless communications is described. The UE may include means for receiving first configuration information that indicates a SBFD resource that includes one or more uplink resources and one or more downlink resources that overlap in time with the one or more uplink resources, means for receiving second configuration information that schedules a LP-WUS during the one or more downlink resources of the SBFD resource, means for receiving third configuration information that schedules an uplink transmission during the one or more uplink resources of the SBFD resource, and means for participating in communications with one or both of the LP-WUS and the uplink transmission during the SBFD resource in accordance with one or more prioritization rules.

A non-transitory computer-readable medium storing code for wireless communications is described. The code may include instructions executable by one or more processors to receive first configuration information that indicates a SBFD resource that includes one or more uplink resources and one or more downlink resources that overlap in time with the one or more uplink resources, receive second configuration information that schedules a LP-WUS during the one or more downlink resources of the SBFD resource, receive third configuration information that schedules an uplink transmission during the one or more uplink resources of the SBFD resource, and participate in communications with one or both of the LP-WUS and the uplink transmission during the SBFD resource in accordance with one or more prioritization rules.

In some examples of the method, UEs, and non-transitory computer-readable medium described herein, participating in the communications may include operations, features, means, or instructions for monitoring for the LP-WUS based on the one or more prioritization rules indicating for the UE to prioritize the LP-WUS over the uplink transmission.

In some examples of the method, UEs, and non-transitory computer-readable medium described herein, the LP-WUS may be dynamically activated and the method, apparatuses, and non-transitory computer-readable medium may include further operations, features, means, or instructions for canceling the uplink transmission in accordance with the one or more prioritization rules indicating for the UE to cancel the uplink transmission based on a difference between a first time at which the UE receives the second configuration information and a second time at which the UE may be scheduled to transmit the uplink transmission being greater than a threshold time.

In some examples of the method, UEs, and non-transitory computer-readable medium described herein, participating in the communications may include operations, features, means, or instructions for transmitting the uplink transmission based on the one or more prioritization rules indicating for the UE to prioritize the uplink transmission over the LP-WUS.

In some examples of the method, UEs, and non-transitory computer-readable medium described herein, transmitting the uplink transmission may include operations, features, means, or instructions for transmitting the uplink transmission via a logical channel, the one or more prioritization rules indicate for the UE to prioritize the uplink transmission over the LP-WUS based on a priority of the logical channel.

In some examples of the method, UEs, and non-transitory computer-readable medium described herein, the LP-WUS may be dynamically activated and the one or more prioritization rules indicate for the UE to transmit the uplink transmission based on a difference between a first time at which the UE receives the second configuration information and a second time at which the UE may be scheduled to transmit the uplink transmission being less than a threshold time.

In some examples of the method, UEs, and non-transitory computer-readable medium described herein, participating in the communications may include operations, features, means, or instructions for transmitting the uplink transmission via a main radio of the UE and monitoring for the LP-WUS via a low-power wake-up radio (LP-WUR) of the UE, where the one or more prioritization rules indicate for the UE to transmit the uplink transmission and monitor for the LP-WUS based on the main radio being separate from the LP-WUR.

Some examples of the method, UEs, and non-transitory computer-readable medium described herein may further include operations, features, means, or instructions for receiving fourth configuration information indicating a change in a schedule associated with the LP-WUS, where participating in the communications includes transmitting the uplink transmission based on the change in the schedule associated with the LP-WUS.

Some examples of the method, UEs, and non-transitory computer-readable medium described herein may further include operations, features, means, or instructions for receiving a control signal indicating the one or more prioritization rules.

In some examples of the method, UEs, and non-transitory computer-readable medium described herein, the uplink transmission includes a physical uplink shared channel (PUSCH) message, a physical uplink control channel (PUCCH) message, a hybrid automatic repeat request (HARQ) feedback message, a scheduling request, or a sounding reference signal (SRS).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports resolving collisions with low-power wake-up signals (LP-WUSs) in subband full-duplex (SBFD) resources in accordance with one or more aspects of the present disclosure.

FIG. 2 shows an example of a wireless communications system that supports resolving collisions with LP-WUSs in SBFD resources in accordance with one or more aspects of the present disclosure.

FIG. 3 shows an example of a process flow that supports resolving collisions with LP-WUSs in SBFD resources in accordance with one or more aspects of the present disclosure.

FIG. 4 shows a block diagram of an apparatus that supports resolving collisions with LP-WUSs in SBFD resources in accordance with one or more aspects of the present disclosure.

FIG. 5 shows a block diagram of a communications manager that supports resolving collisions with LP-WUSs in SBFD resources in accordance with one or more aspects of the present disclosure.

FIG. 6 shows a diagram of a system including a device that supports resolving collisions with LP-WUSs in SBFD resources in accordance with one or more aspects of the present disclosure.

FIGS. 7 through 9 show flowcharts illustrating methods that support resolving collisions with LP-WUSs in SBFD resources in accordance with one or more aspects of the present disclosure.

### DETAILED DESCRIPTION

In some wireless communications systems, a network entity may use subband full-duplex (SBFD) techniques in which the network entity may simultaneously transmit downlink signaling and receive uplink signaling (e.g., in a same slot via respective non-overlapping frequency subbands). In such examples, a user equipment (UE) may operate according to half-duplex (HD) techniques in which the UE may either receive the downlink signaling or transmit the uplink signaling in a given time resource (e.g., a slot). Accordingly, the UE may identify one or more prioritization rules to determine whether the UE may receive the downlink signaling or transmit the uplink signaling.

In some examples, the UE may include a main radio and a low-power wake-up radio (LP-WUR) that the UE may use to monitor for signaling. For example, the UE may reduce power consumption by refraining from monitoring for downlink messages (e.g., physical downlink control channel (PDCCH) messages) via the main radio until the UE receives a low-power wake-up signal (LP-WUS) from the network entity that instructs the UE to monitor for the downlink messages. In some examples, however, the UE may be scheduled to transmit an uplink message (e.g., a semi-static uplink message, such as a physical uplink shared channel (PUSCH) message, a physical uplink control channel (PUCCH) message, or a sounding reference signal (SRS)) in a same slot as a scheduled LP-WUS, and the UE may be unaware of whether to monitor for the LP-WUS or to transmit the uplink message.

Accordingly, techniques described herein may enable the UE to identify one or more prioritization rules for monitoring for LP-WUSs or transmitting uplink messages in a SBFD slot. For example, the prioritization rules may instruct the UE to prioritize the LP-WUS over the uplink message. Additionally, or alternatively, the prioritization rules may instruct the UE to prioritize the LP-WUS over the uplink message if the LP-WUS is semi-statically activated, and to prioritize the LP-WUS over the uplink message if the LP-WUS is dynamically activated and the UE determines that a timeline between the activation of the LP-WUS and transmission of the uplink signal is sufficient for cancellation. Additionally, or alternatively, the prioritization rules may instruct the UE to prioritize the uplink message over the LP-WUS (e.g., for a relatively higher priority uplink message). In some examples, the UE may monitor for the LP-WUS (e.g., with the LP-WUR) and transmit the uplink message (e.g., with the main radio). In some examples, the UE may receive configuration information (e.g., a radio resource control (RRC) message) indicating the one or more prioritization rules.

Aspects of the disclosure are initially described in the context of wireless communications systems. Aspects of the disclosure are further illustrated by and described with reference to process flows, apparatus diagrams, system diagrams, and flowcharts that relate to resolving collisions with LP-WUSs in SBFD resources.

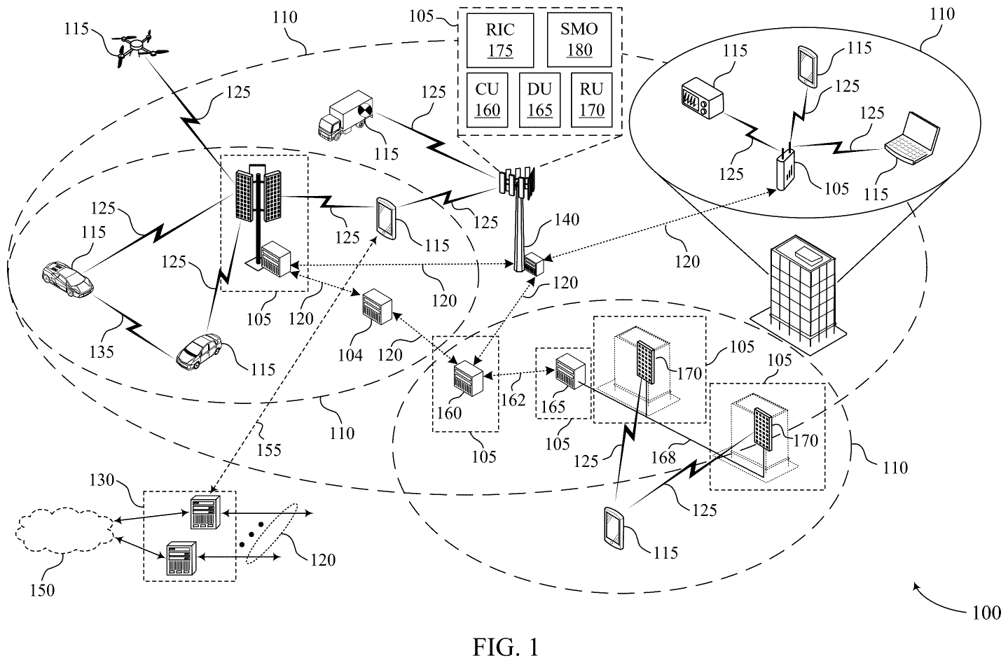

FIG. 1 shows an example of a wireless communications system 100 that supports resolving collisions with LP-WUSs in SBFD resources in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), monitoring for LP-WUSs using an LP-WUR, or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support half-duplex communications (e.g., frequency division duplexing (FDD) or time division duplexing (TDD), in which a UE 115 or a network entity 105 may perform communication of downlink signaling and communication of uplink signaling via resources that do not overlap in time or frequency, respectively. For example, for FDD operations, the network entity 105 may allocate a dedicated downlink transmission frequency bandwidth, a dedicated uplink transmission frequency bandwidth, and a dedicated supplementary uplink frequency bandwidth (e.g., defined by a central frequency and a frequency range or quantity of resource blocks (RBs)), and may schedule the downlink and uplink communications in overlapping time resources. For TDD operations, the network entity 105 may allocate a dedicated downlink and uplink transmission frequency bandwidth and a dedicated supplementary uplink frequency bandwidth (e.g., defined by a central frequency and a frequency range or quantity of RBs), and may schedule the downlink and uplink communications in non-overlapping time resources.

In some examples, the wireless communications system 100 may support full-duplex communications, in which a UE 115 or a network entity 105 may perform simultaneous communication of downlink signaling and communication of uplink signaling on a frequency subband basis (e.g., across a set of frequencies). For example, for SBFD communications, the network entity 105 may partition a particular frequency band (e.g., 100 MHz) into subbands which the network entity 105 may use exclusively for uplink or downlink communications. For example, the network entity 105 may use the 40 MHz of a 100 MHz band for downlink communications, 20 MHz for uplink communications, and another 40 MHz again for downlink communications. That is, the uplink and downlink subbands may have relatively similar frequencies, however, may be non-overlapping in frequency. Full-duplex communications may be suitable for macro cells with a large transmit power, and may be relatively simpler to enable than other full-duplex techniques. In some examples, such SBFD communication techniques may also support a dedicated frequency band for supplementary uplink communications, as described with reference to FDD and TDD communications.

To further enhance flexibility of some operations, the wireless communications system 100 may support UEs 115 and network entities 105 which may both perform simultaneous transmission and reception of downlink and uplink communications via partially or fully overlapping frequency bands. For example, the wireless communications system 100 may support a network entity 105 that operates using full-duplex communications via partially overlapping frequency bands, or a network entity 105 that operates using half-duplex communications (e.g., in a multi-transmission reception point (mTRP)) scenario) and a UE 115 that operates using full-duplex communications.

In some scenarios, network entities 105 in the wireless communications system 100 may support full-duplex operations (e.g., where a network entity 105 may communicate simultaneously on uplink and downlink subbands that are non-overlapping in frequency), while UEs 115 may support half-duplex communications. For example, the network entity 105 may use a particular subband for transmitting downlink communications to a first UE 115, and a particular subband for receiving simultaneous uplink communications from a second UE 115. As such, a UE 115 capable of half-duplex communications may be paired with any network entity 105 capable of full-duplex operations in the wireless communications system 100.

In some examples, the network entity 105 may use IBFD communications, in which the network entity 105 may transmit and receive communications with a UE 115 via a same time resource and a same frequency resource. That is, the downlink and uplink may share same IBFD time and frequency resources, which may partially or fully overlap. Alternatively, the network entity 105 may use SBFD (e.g., flexible duplex) communications, in which the network entity 105 may transmit and receive communications with the UE 115 via a same time resource but via different frequency resources. That is, a frequency resource used for downlink communications may be separated from a frequency resource used for uplink communications (e.g., by a guard band). In some examples, the network entity 105 may use SBHD, in which the network entity 105 may transmit and receive communications with the UE 115 via frequency subbands that do not overlap in time or frequency. Such techniques may allow for the network entity 105 to transition between a half-duplex mode (e.g., TDD or FDD) and a full-duplex mode (e.g., SBFD, IBFD).

In some examples of the wireless communications system 100, a UE 115 may identify one or more prioritization rules for monitoring for LP-WUSs or transmitting uplink messages in a SBFD slot (e.g., a slot configured with both uplink and downlink resources). For example, the prioritization rules may instruct the UE 115 to prioritize the LP-WUS over the uplink message. Additionally, or alternatively, the prioritization rules may instruct the UE 115 to prioritize the LP-WUS over the uplink message if the LP-WUS is semi-statically activated, and to prioritize the LP-WUS over the uplink message if the LP-WUS is dynamically activated and the UE 115 determines that a timeline between the activation of the LP-WUS and transmission of the uplink signal is sufficient for cancellation. Additionally, or alternatively, the prioritization rules may instruct the UE 115 to prioritize the uplink message over the LP-WUS (e.g., for a relatively higher priority uplink message). In some examples, the UE 115 may monitor for the LP-WUS (e.g., with the LP-WUR) and transmit the uplink message (e.g., with a main radio of the UE 115). In some examples, the UE 115 may receive configuration information (e.g., RRC message) indicating the one or more prioritization rules.

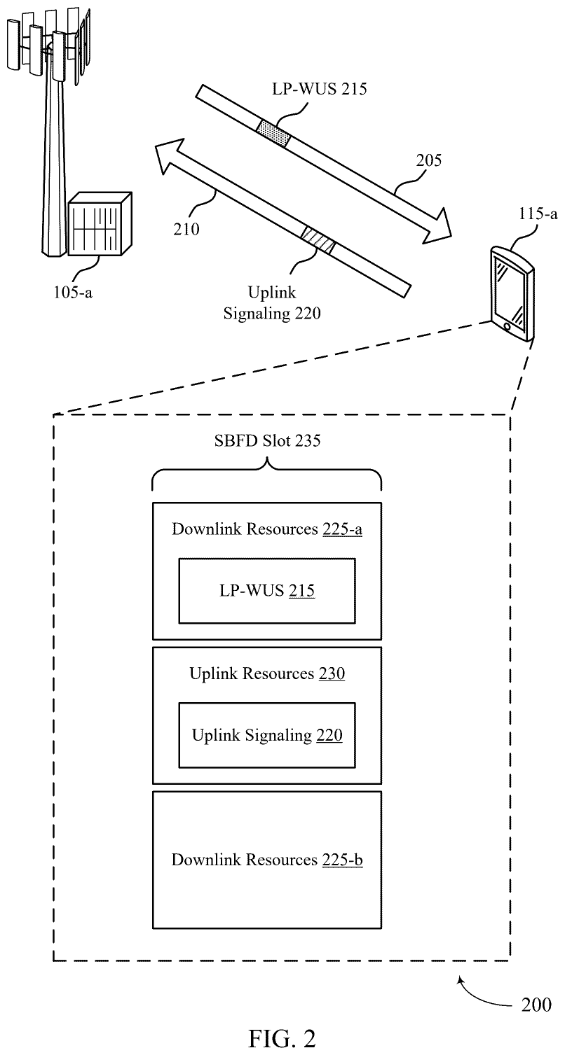

FIG. 2 shows an example of a wireless communications system 200 that supports resolving collisions with LP-WUSs in SBFD resources in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or a network entity 105 (e.g., a network entity 105-a), which may be examples of the corresponding devices as described with reference to FIG. 1.

In some examples of the wireless communications system 200, a UE 115-a may communicate with a network entity 105-a. For example, the UE 115-a may transmit uplink signaling 220 (e.g., a PUSCH message, a PUCCH message, an SRS, a random access channel (RACH) message) to the network entity 105-a via an uplink channel 210. The UE 115-a may receive downlink signaling (e.g., a physical downlink control channel (PDCCH) message, a physical downlink shared channel (PDSCH) message, a channel state information reference signal (CSI-RS), a synchronization signal block (SSB), a tracking reference signal (TRS), a cooperative spectrum sensing (CSS) message) from the network entity 105-a via a downlink channel 205.

In some examples, the network entity 105-a may communicate with one or more UEs 115 using SBFD techniques. For example, the network entity 105-a may configure an SBFD slot 235 with one or more frequency subbands over which the network entity 105-a may communicate both uplink signaling 220 and downlink signaling. The SBFD slot 235 may include downlink resources 225 (e.g., downlink resources 225-a, downlink resources 225-b) and uplink resources 230 in respective frequency subbands (e.g., separated by one or more guard bands). The network entity 105-a may accordingly transmit downlink signaling via the downlink resources 225-a and the downlink resources 225-b and receive uplink signaling 220 via the uplink resources 230.

In some examples, the UE 115-a may be an SBFD-aware half-duplex UE 115 configured with uplink subbands within downlink symbols. That is, the network entity 105-a may indicate, to the UE 115-a, a configuration for the SBFD slot 235. The UE 115-a may accordingly either monitor for downlink signaling via the downlink resources 225-a and the downlink resources 225-b or transmit uplink signaling 220 via the uplink resources 230. The UE 115-a may determine whether to transmit or receive via the SBFD slot 235.

For example, the UE 115-a may treat SBFD symbols of the SBFD slot 235 as flexible symbols for which the UE 115-a may determine a traffic direction based on dynamic scheduling (e.g., monitoring for PDCCH candidates) or semi-static signaling. Additionally, or alternatively, the UE 115-a may identify a default communication direction for the SBFD slot 235 (e.g., based on receiving a parameter such as TDD-ULDL-Dedicated via an RRC configuration).

In some examples, however, the UE 115-a may be scheduled with a time-domain collision in the SBFD slot 235. For example, the UE 115-a may be scheduled to both receive downlink signaling and to transmit uplink signaling 220 via at least one overlapping symbol (e.g., OFDM symbol) in a same SBFD slot 235, or the UE 115-a may determine that a time between a scheduled downlink reception and uplink transmission is less than a threshold time (e.g., a time for transmission/reception switching).

Accordingly, the UE 115-a may determine (e.g., based on a configuration received from the network entity 105-a or based on a rule defined in a technical specification) one or more prioritization rules for whether to prioritize monitoring for messages scheduled in the downlink resources 225-a and the downlink resources 225-b or transmitting messages scheduled in the uplink resources 230 when the UE 115-a identifies a collision. The one or more rules may be based on whether the uplink transmission and downlink reception are semi-static or dynamic, and a type of message associated with the downlink reception and uplink transmission (e.g., whether the uplink transmission is a physical random access channel (PRACH) message in a RACH occasion (RO), whether the downlink reception is an SSB, and so on).

The prioritization rules may instruct the UE 115-a to cancel one or more messages, to prioritize one or more messages, and/or to not expect one or more conflicts (e.g., the network entity 105-a may not be allowed to schedule the UE 115-a with some types of conflicting downlink messages and uplink messages in a same SBFD slot). Some illustrative examples of prioritization rules are provided below in Table 1 and Table 2.

TABLE 1

| | | Downlink Reception | | |
|---|---|---|---|---|
| | | Semi-Static | | |
| | | Downlink | Dynamic | |
| | | (PDCCH, | Downlink | |
| | | PDSCH, CSI- | (PDSCH, | SSB and |
| | | RS, TRS) | CSI-RS) | Type0 CSS |
| Uplink | Semi- | See Table 2 | Cancel uplink | Prioritize |
| Transmission | Static | | within | SSB |
| | Uplink | | cancellation | |
| | (SRS, | | timeline | |
| | PUCCH, | | | |
| | PUSCH) | | | |
| | Dynamic | Cancel | Not expected | Prioritize |
| | Uplink | Downlink | (Error Case) | SSB |
| | (SRS, | | | |
| | PUCCH, | | | |
| | PUSCH) | | | |
| | RACH | RRC-PRACH: | Cancel RRC- | Not Allowed |
| | Occasion | See Table 2; | PRACH within | |
| | (RO) | PDCCH order: | cancellation | |
| | | higher | timeline; | |
| | | | PDCCH order: | |
| | | | not allowed | |

TABLE 2

| | | Semi-Static Downlink | | | |
|---|---|---|---|---|---|
| | | PDCCH (Monitoring | | | |
| | | Occasion (MO)/ | | | |
| | | Search Space (SS)) | PDSCH | CSI-RS | TRS |
| Uplink | SRS, PUCCH, | Prioritize | Prioritize | Prioritize | Prioritize |
| Transmission | PUSCH | PDCCH | Uplink | Uplink | TRS |
| | | | Transmission | Transmission | |
| | RO | Prioritize | Prioritize | Prioritize | Prioritize |
| | | PRACH | PRACH | PRACH | PRACH |

In some examples, the UE 115-a may have multiple radios via which the UE 115-a may transmit and receive signaling. For example, the UE 115-a may have a main radio and a LP-WUR. The UE 115-a may use the LP-WUR for power conservation techniques. For example, the UE 115-a may refrain from monitoring for one or more downlink messages (e.g., a paging PDCCH if the UE 115-a is in an idle or inactive mode or a data scheduling PDCCH if the UE 115-a is in a connected mode) via the main radio until the UE 115-a receives a LP-WUS 215 via the LP-WUR (e.g., or via the main radio if the UE 115-a is in the connected mode). If the UE 115-a is in the idle or inactive mode, the UE 115-a may monitor for the LP-WUS 215 to trigger monitoring for a paging PDCCH. If the UE 115-a is in the connected mode, the UE 115-a may monitor for the LP-WUS 215 to trigger the UE 115-a to enter into an upcoming discontinuous reception (DRX) On-Duration, to monitor for a PDCCH in a DRX active time duration, and/or to monitor for a PDCCH outside of the DRX active time duration. The UE 115-a may accordingly “wake up” (e.g., activate) the main radio of the UE 115-a to monitor for a PDCCH in response to receiving the LP-WUS 215.

In some examples, the UE 115-a may monitor for the LP-WUS 215 prior to the connected mode DRX (CDRX) On-Duration to indicate whether the UE 115-a may enter the On-Duration (e.g., in lieu of a downlink control information (DCI) of power saving (DCP)). Additionally, or alternatively, the UE 115-a may monitor for the LP-WUS 215 outside of the CDRX active time to trigger PDCCH monitoring outside of the CDRX active time. For example, the UE 115-a may receive a PDCCH message outside of the CDRX active time in response to receiving the LP-WUS 215. Additionally, or alternatively, the UE 115-a may monitor for the LP-WUS 215 inside the CDRX active time to trigger PDCCH monitoring inside of the CDRX active time. For example, the UE 115-a may receive a PDCCH message inside of the CDRX active time in response to receiving the LP-WUS 215.

In some cases, the UE 115-a may be scheduled (e.g., by the network entity 105-a) to monitor for the LP-WUS 215 (e.g., via the downlink resources 225-a and/or the downlink resources 225-b) in a same SBFD slot 235 in which the UE 115-a is scheduled to transmit uplink signaling 220 (e.g., via the uplink resources 230). The collision rules illustrated with reference to Table 1 and Table 2 may not provide prioritization rules for the UE 115-a to determine whether to monitor for the LP-WUS 215 or to transmit the uplink signaling 220.

Accordingly, in some implementations, the UE 115-a may identify one or more prioritization rules for the UE 115-a to determine whether to monitor for the LP-WUS 215 or to transmit the uplink signaling 220 (e.g., via the main radio of the UE 115-a when the UE 115-a is in an RRC connected mode). For example, if time resources scheduled for the LP-WUS 215 collide (e.g., partially or completely overlap) with time resources scheduled for the uplink signaling 220 (e.g., a semi-static uplink message such as a configured grant PUSCH message or an SRS), the one or more prioritization rules may indicate for the UE 115-a to consider the LP-WUS 215 as a higher priority than the uplink signaling 220. The UE 115-a may accordingly monitor for the LP-WUS 215 and refrain from transmitting (e.g., cancel transmission of) the uplink signaling 220. In such examples, the UE 115-a may monitor for the LP-WUS 215 in response to the LP-WUS 215 causing the UE 115-a to monitor for a PDCCH message, which may have a relatively higher priority than the uplink signaling 220 (e.g., as illustrated with reference to Table 2).

Additionally, or alternatively, the one or more prioritization rules may indicate for the UE 115-a to prioritize one of the LP-WUS 215 or the uplink signaling based on whether the LP-WUS 215 is dynamically activated or semi-statically activated. For example, if the LP-WUS 215 is semi-statically activated, the one or more prioritization rules may indicate for the UE 115-a to consider the LP-WUS 215 as a higher priority than the uplink signaling 220. The UE 115-a may accordingly monitor for the LP-WUS 215 and refrain from transmitting (e.g., cancel transmission of) the uplink signaling 220. If the LP-WUS 215 is dynamically activated (e.g., via DCI), the UE 115-a may determine whether a first time between when the LP-WUS 215 is scheduled (e.g., a time at which the UE 115-a receives the DCI) and a second time at which the UE 115-a is scheduled to transmit the uplink signaling 220 is greater than a threshold time (e.g., a sufficient cancellation timeline). If the time between the first time and the second time is greater than the threshold time, the one or more prioritization rules may indicate for the UE 115-a to cancel the uplink signaling 220 and monitor for the LP-WUS 215. If the time between the first time and the second time is not greater than the threshold time, the one or more prioritization rules may indicate for the UE 115-a to transmit the uplink signaling 220 and refrain from monitoring for the LP-WUS 215.

Additionally, or alternatively, the one or more prioritization rules may be based on a priority associated with a logical channel (e.g., the uplink channel 210) over which the UE 115-a may transmit the uplink signaling 220. For example, the logical channel over which the UE 115-a may transmit the uplink signaling 220 may have a relatively higher priority (e.g., for a HARQ feedback message such as a HARQ ACK, an SRS, or a scheduling request) than the LP-WUS 215. The one or more prioritization rules may accordingly indicate for the UE 115-a to transmit the uplink signaling 220 and refrain from monitoring for the LP-WUS 215.

Additionally, or alternatively, the one or more prioritization rules may indicate for the UE 115-a to transmit the uplink signaling 220 (e.g., semi-static uplink messages) and refrain from monitoring for the LP-WUS 215. The UE 115-a may accordingly transmit the uplink signaling 220 and refrain from monitoring for the LP-WUS 215.

In some examples, the UE 115-a may receive (e.g., from the network entity 105-a) an indication of a change in a schedule (e.g., a change in periodicity and/or resources) associated with the LP-WUS 215. For example, the network entity 105-a may indicate, based on LP-WUS adaptation via DCI, a medium access control (MAC) control element (CE) message, or an RRC message, that the LP-WUS 215 is no longer scheduled in time resources that collide (e.g., partially or fully) with the time resources scheduled for the uplink signaling 220. The UE 115-a may accordingly update the one or more prioritization rules. For example, the one or more prioritization rules may indicate for the UE 115-a to transmit the uplink signaling 220 and refrain from monitoring for the LP-WUS 215 if the UE 115-a has a sufficient timeline to prepare the uplink signaling 220 (e.g., a PUSCH or SRS). In some examples, the timeline to prepare the uplink signaling 220 may be based on an N2 timeline.

In some examples, the one or more prioritization rules may be the same or different depending on whether the UE 115-a (e.g., a half-duplex UE 115) performs both monitoring for the LP-WUS 215 and transmitting the uplink signaling 220 via the main radio, or whether the UE 115-a performs monitoring for the LP-WUS 215 via the LP-WUR and transmitting the uplink signaling 220 via the main radio. For example, the one or more prioritization rules may indicate for the UE 115-a to transmit the uplink signaling 220 and refrain from monitoring for the LP-WUS 215 or to monitor for the LP-WUS 215 and refrain from transmitting (e.g., cancel transmission of) the uplink signaling 220 regardless of whether the UE 115-a monitors for the LP-WUS 215 via the LP-WUR or via the main radio. Additionally, or alternatively, the one or more prioritization rules may be different depending on whether the UE 115-a uses a time offset to wake up the main radio after receiving the LP-WUS 215.

In some examples, the UE 115-a may use independent hardware for the main radio and for the LP-WUR. Accordingly, the UE 115-a may perform transmission via the main radio and reception via the LP-WUR simultaneously. In such examples, the one or more prioritization rules may indicate for the UE 115-a to transmit the uplink signaling 220 (e.g., refrain from canceling the uplink signaling 220) via the main radio and to monitor for the LP-WUS 215 via the LP-WUR (e.g., simultaneously). The UE 115-a may subsequently monitor for a PDCCH message via the main radio. In such examples, the SBFD slot 235 may include one or more guard bands to reduce self-interference at the UE 115-a, or the UE 115-a may include one or more components to reduce self-interference.

In some examples, the one or more prioritization rules may be defined according to a rule in a technical specification. Additionally, or alternatively, the network entity 105-a may transmit control signaling (e.g., an RRC message) configuring the UE 115-a with the one or more prioritization rules. In such examples, the network entity 105-a may transmit additional control signaling (e.g., an RRC message, a MAC-CE message, DCI) indicating an update to the one or more prioritization rules.

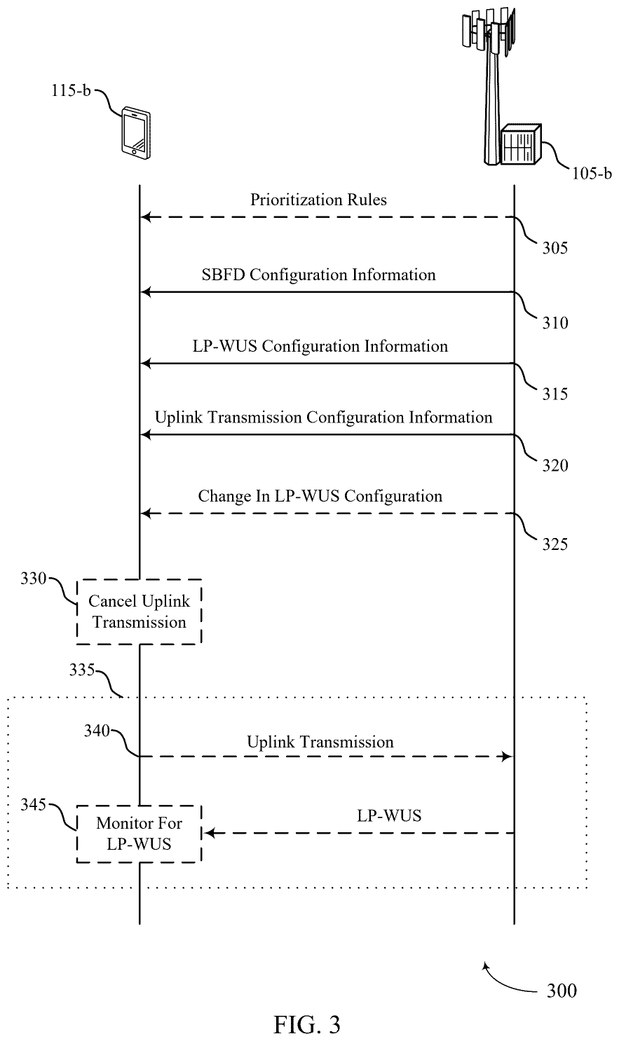

FIG. 3 shows an example of a process flow 300 that supports resolving collisions with LP-WUSs in SBFD resources in accordance with one or more aspects of the present disclosure. The process flow 300 may implement or may be implemented by aspects of the wireless communications system 100 or the wireless communications system 200. For example, the process flow 300 may be implemented by a UE 115 (e.g., a UE 115-b) or a network entity 105 (e.g., a network entity 105-b), which may be examples of the corresponding devices as described with reference to FIG. 1. In some examples, the UE 115-b may be an SBFD-aware UE 115.

In the following description of the process flow 300, the operations between the UE 115-b and the network entity 105-b may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

In some examples, at 305, the UE 115-b may receive, from the network entity 105-b, a configuration message (e.g., an RRC message, an SIB) indicating one or more prioritization rules for resolving an uplink transmission and an LP-WUS that may be scheduled in respective subbands of an SBFD slot. Additionally, or alternatively, the UE 115-b may identify the prioritization rules without receiving the configuration message. For example, the prioritization rules may be pre-configured at the UE 115-b and/or defined according to a rule in a technical specification.

In some examples, the one or more prioritization rules may indicate for the UE 115-b to refrain from transmitting the uplink transmission and to monitor for the LP-WUS. In some examples, the one or more prioritization rules may indicate for the UE 115-b to transmit the uplink transmission and to refrain from monitoring for the LP-WUS. In some examples, the one or more prioritization rules may indicate for the UE 115-b to transmit the uplink transmission and to monitor for the LP-WUS (e.g., via a main radio and a LP-WUR of the UE 115-b, respectively).

At 310, the UE 115-b may receive first configuration information from the network entity 105-b indicating an SBFD configuration. For example, the UE 115-b may receive information indicating that first resources (e.g., a first slot) are SBFD resources. The UE 115-b may accordingly identify that the first resources include an uplink frequency subband and one or more downlink frequency subbands that overlap in time with the uplink frequency subband, as illustrated with reference to FIG. 2.

At 315, the UE 115-b may receive second configuration information from the network entity 105-b indicating a configuration for an LP-WUS. For example, the second configuration information may indicate one or more resources for the LP-WUS, a periodicity for the LP-WUS, a waveform for the LP-WUS, and the like.

At 320, the UE 115-b may receive third configuration information indicating a configuration for an uplink transmission. In some examples, the uplink transmission and the LP-WUS may be scheduled in the SBFD resources (e.g., in overlapping time resources and non-overlapping frequency resources). In some examples, the second configuration information and the third configuration information may be indicated via a same message (e.g., an RRC message, a MAC-CE message, a DCI message) from the network entity 105-b.

In some examples, at 325, the UE 115-b may receive, from the network entity 105-b, a change in the LP-WUS configuration. For example, the network entity 105-b may indicate, to the UE 115-b, that the periodicity and/or the resources for the LP-WUS have changed. In such examples, the UE 115-b may determine that the LP-WUS and the uplink transmissions are no longer scheduled in overlapping time resources.

In some examples, at 330, the UE 115-b may cancel the uplink transmission (e.g., if the LP-WUS is dynamically activated). For example, the UE 115-b may determine that a time between receiving the LP-WUS configuration and the resources allocated for the uplink transmission are greater than a threshold time. In such examples, the one or more prioritization rules may indicate for the UE 115-b to cancel the uplink transmission.

At 335, the UE 115-b and the network entity 105-b may participate in communications of one or both of the uplink transmission and the LP-WUS. For example, the UE 115-b may determine whether to transmit the uplink transmission, monitor for the LP-WUS, or both in accordance with the one or more prioritization rules.

For example, at 340, the UE 115-b may transmit the uplink transmission to the network entity 105-b in accordance with the one or more prioritization rules. For example, the one or more prioritization rules may indicate that the UE 115-b may transmit the uplink transmission. The uplink transmission may be, for example, a PUSCH message, a PUCCH message, a HARQ feedback message, a scheduling request, and/or an SRS.

In some examples, the one or more prioritization rules may indicate for the UE 115-b to transmit the uplink transmission based on a priority of a logical channel over which the UE 115-b transmits the uplink transmission. Additionally, or alternatively, the one or more prioritization rules may indicate for the UE 115-b to transmit the uplink transmission based on the time between receiving the LP-WUS configuration and the resources allocated for the uplink transmission being less than the threshold time. Additionally, or alternatively, the one or more prioritization rules may indicate for the UE 115-b to prioritize the uplink transmission over the LP-WUS. Additionally, or alternatively, the one or more prioritization rules may indicate for the UE 115-b to transmit the uplink transmission based on the change in the LP-WUS configuration indicating that the uplink transmission does not overlap in time with the LP-WUS. Additionally, or alternatively, the one or more prioritization rules may indicate for the UE 115-b to transmit the uplink transmission based on a type of uplink transmission (e.g., based on whether the uplink transmission is a PUSCH message, a PUCCH message, a HARQ feedback message, a scheduling request, and/or an SRS).

Additionally, or alternatively, at 345, the UE 115-b may monitor for the LP-WUS from the network entity 105-b in accordance with the one or more prioritization rules. For example, the one or more prioritization rules may indicate that the UE 115-b may monitor for the LP-WUS.

In some examples, the one or more prioritization rules may indicate for the UE 115-b to monitor for the LP-WUS based on the time between receiving the LP-WUS configuration and the resources allocated for the uplink transmission being greater than the threshold time (e.g., and accordingly based on the UE 115-b canceling the uplink transmission). Additionally, or alternatively, the one or more prioritization rules may indicate for the UE 115-b to prioritize the LP-WUS over the uplink transmission. Additionally, or alternatively, the one or more prioritization rules may indicate for the UE 115-b to monitor for the LP-WUS based on the change in the LP-WUS configuration indicating that the uplink transmission does not overlap in time with the LP-WUS.

In some examples, the UE 115-b may both monitor for the LP-WUS and transmit the uplink transmission. For example, if the UE 115-b monitors for the LP-WUS via a LP-WUR of the UE 115-b and transmits the uplink transmission via a main radio of the UE 115-b that is independent of the LP-WUR, the one or more prioritization rules may indicate for the UE 115-b to both monitor for the LP-WUS and transmit the uplink transmission.

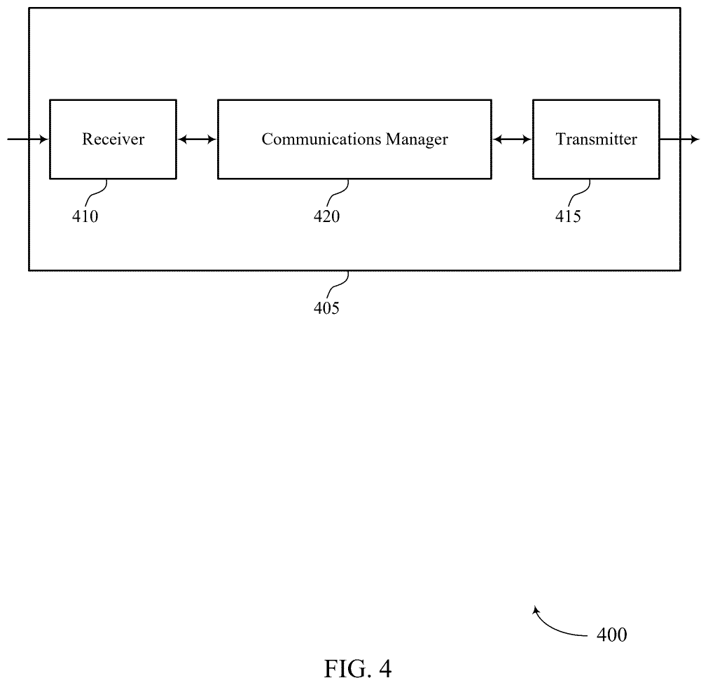

FIG. 4 shows a block diagram 400 of a device 405 that supports resolving collisions with LP-WUSs in SBFD resources in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to resolving collisions with LP-WUSs in SBFD resources). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to resolving collisions with LP-WUSs in SBFD resources). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of resolving collisions with LP-WUSs in SBFD resources as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving first configuration information that indicates a SBFD resource that includes one or more uplink resources and one or more downlink resources that overlap in time with the one or more uplink resources. The communications manager 420 is capable of, configured to, or operable to support a means for receiving second configuration information that schedules a LP-WUS during the one or more downlink resources of the SBFD resource. The communications manager 420 is capable of, configured to, or operable to support a means for receiving third configuration information that schedules an uplink transmission during the one or more uplink resources of the SBFD resource. The communications manager 420 is capable of, configured to, or operable to support a means for participating in communications with one or both of the LP-WUS and the uplink transmission during the SBFD resource in accordance with one or more prioritization rules.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for determining prioritization for LP-WUSs and uplink transmissions for SBFD-aware UEs, which may result in reduced power consumption and more efficient utilization of communication resources.

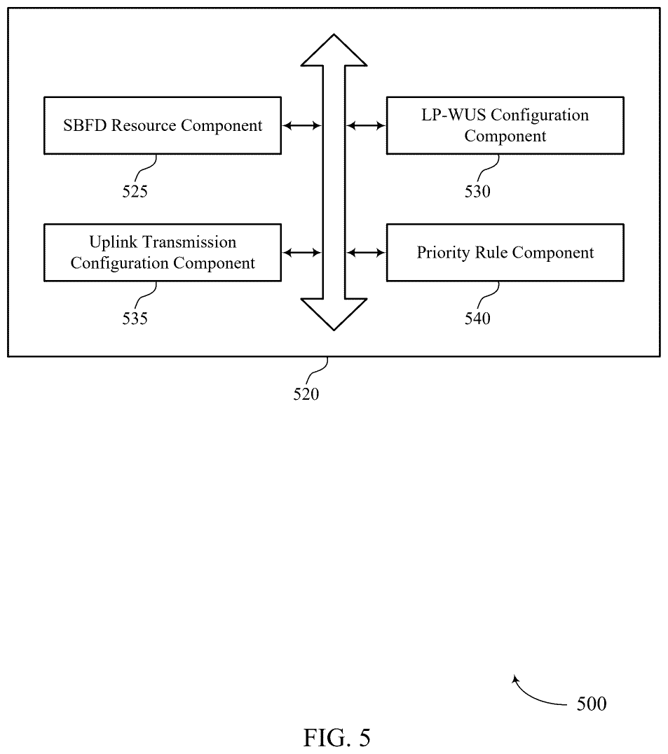

FIG. 5 shows a block diagram 500 of a communications manager 520 that supports resolving collisions with LP-WUSs in SBFD resources in accordance with one or more aspects of the present disclosure. The communications manager 520 may be an example of aspects of a communications manager or a communications manager 420, or both, as described herein. The communications manager 520, or various components thereof, may be an example of means for performing various aspects of resolving collisions with LP-WUSs in SBFD resources as described herein. For example, the communications manager 520 may include an SBFD resource component 525, an LP-WUS configuration component 530, an uplink transmission configuration component 535, a priority rule component 540, or any combination thereof. Each of these components, or components or subcomponents thereof (e.g., one or more processors, one or more memories), may communicate, directly or indirectly, with one another (e.g., via one or more buses).

The communications manager 520 may support wireless communications in accordance with examples as disclosed herein. The SBFD resource component 525 is capable of, configured to, or operable to support a means for receiving first configuration information that indicates a SBFD resource that includes one or more uplink resources and one or more downlink resources that overlap in time with the one or more uplink resources. The LP-WUS configuration component 530 is capable of, configured to, or operable to support a means for receiving second configuration information that schedules a LP-WUS during the one or more downlink resources of the SBFD resource. The uplink transmission configuration component 535 is capable of, configured to, or operable to support a means for receiving third configuration information that schedules an uplink transmission during the one or more uplink resources of the SBFD resource. The priority rule component 540 is capable of, configured to, or operable to support a means for participating in communications with one or both of the LP-WUS and the uplink transmission during the SBFD resource in accordance with one or more prioritization rules.

In some examples, to support participating in the communications, the priority rule component 540 is capable of, configured to, or operable to support a means for monitoring for the LP-WUS based on the one or more prioritization rules indicating for the UE to prioritize the LP-WUS over the uplink transmission.

In some examples, the LP-WUS is dynamically activated, and the priority rule component 540 is capable of, configured to, or operable to support a means for canceling the uplink transmission in accordance with the one or more prioritization rules indicating for the UE to cancel the uplink transmission based on a difference between a first time at which the UE receives the second configuration information and a second time at which the UE is scheduled to transmit the uplink transmission being greater than a threshold time.

In some examples, to support participating in the communications, the priority rule component 540 is capable of, configured to, or operable to support a means for transmitting the uplink transmission based on the one or more prioritization rules indicating for the UE to prioritize the uplink transmission over the LP-WUS.

In some examples, to support transmitting the uplink transmission, the priority rule component 540 is capable of, configured to, or operable to support a means for transmitting the uplink transmission via a logical channel, the one or more prioritization rules indicate for the UE to prioritize the uplink transmission over the LP-WUS based on a priority of the logical channel.

In some examples, the LP-WUS is dynamically activated. In some examples, the one or more prioritization rules indicate for the UE to transmit the uplink transmission based on a difference between a first time at which the UE receives the second configuration information and a second time at which the UE is scheduled to transmit the uplink transmission being less than a threshold time.

In some examples, to support participating in the communications, the priority rule component 540 is capable of, configured to, or operable to support a means for transmitting the uplink transmission via a main radio of the UE. In some examples, to support participating in the communications, the priority rule component 540 is capable of, configured to, or operable to support a means for monitoring for the LP-WUS via a LP-WUR of the UE, where the one or more prioritization rules indicate for the UE to transmit the uplink transmission and monitor for the LP-WUS based on the main radio being separate from the LP-WUR.

In some examples, the LP-WUS configuration component 530 is capable of, configured to, or operable to support a means for receiving fourth configuration information indicating a change in a schedule associated with the LP-WUS. In some examples, the priority rule component 540 is capable of, configured to, or operable to support a means for transmitting the uplink transmission based on the change in the schedule associated with the LP-WUS.

In some examples, the priority rule component 540 is capable of, configured to, or operable to support a means for receiving a control signal indicating the one or more prioritization rules.

In some examples, the uplink transmission includes a PUSCH message, a PUCCH message, a HARQ feedback message, a scheduling request, or a SRS.

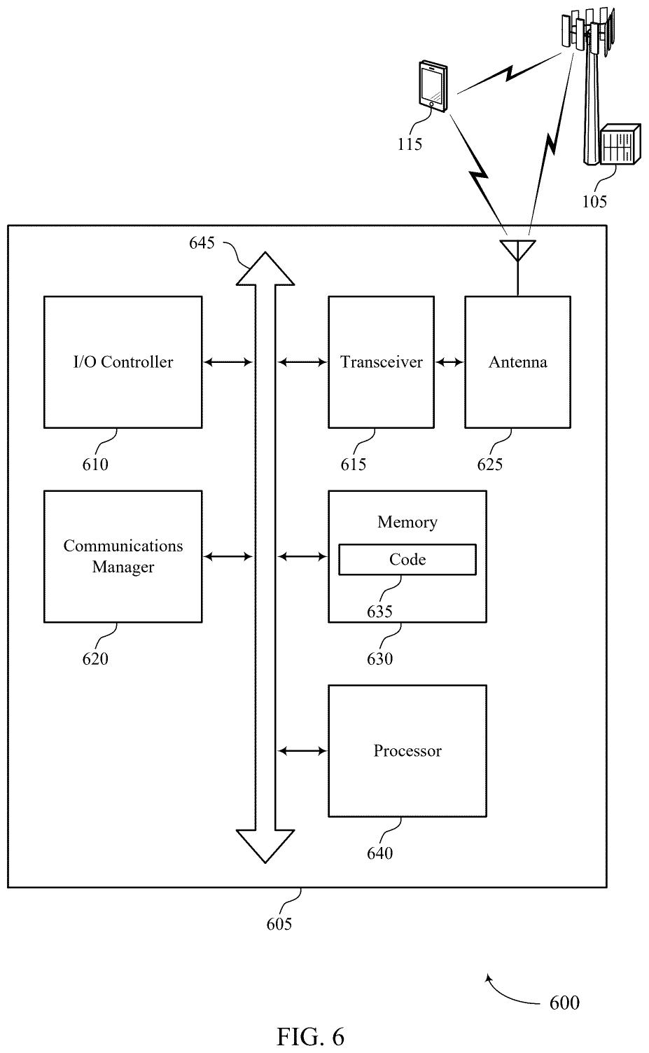

FIG. 6 shows a diagram of a system 600 including a device 605 that supports resolving collisions with LP-WUSs in SBFD resources in accordance with one or more aspects of the present disclosure. The device 605 may be an example of or include components of a device 405 as described herein. The device 605 may communicate (e.g., wirelessly) with one or more other devices (e.g., network entities 105, UEs 115, or a combination thereof). The device 605 may include components for bi-directional voice and data communications including components for transmitting and receiving communications, such as a communications manager 620, an input/output (I/O) controller, such as an I/O controller 610, a transceiver 615, one or more antennas 625, at least one memory 630, code 635, and at least one processor 640. These components may be in electronic communication or otherwise coupled (e.g., operatively, communicatively, functionally, electronically, electrically) via one or more buses (e.g., a bus 645).

The I/O controller 610 may manage input and output signals for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some cases, the I/O controller 610 may be implemented as part of one or more processors, such as the at least one processor 640. In some cases, a user may interact with the device 605 via the I/O controller 610 or via hardware components controlled by the I/O controller 610.

In some cases, the device 605 may include a single antenna. However, in some other cases, the device 605 may have more than one antenna, which may be capable of concurrently transmitting or receiving multiple wireless transmissions. The transceiver 615 may communicate bi-directionally via the one or more antennas 625 using wired or wireless links as described herein. For example, the transceiver 615 may represent a wireless transceiver and may communicate bi-directionally with another wireless transceiver. The transceiver 615 may also include a modem to modulate the packets, to provide the modulated packets to one or more antennas 625 for transmission, and to demodulate packets received from the one or more antennas 625. The transceiver 615, or the transceiver 615 and one or more antennas 625, may be an example of a transmitter 415, a transmitter {#FigRef.B.transmitter}, a receiver 410, a receiver {#FigRef.B.receiver}, or any combination thereof or component thereof, as described herein.

The at least one memory 630 may include random access memory (RAM) and read-only memory (ROM). The at least one memory 630 may store computer-readable, computer-executable, or processor-executable code, such as the code 635. The code 635 may include instructions that, when executed by the at least one processor 640, cause the device 605 to perform various functions described herein. The code 635 may be stored in a non-transitory computer-readable medium such as system memory or another type of memory. In some cases, the code 635 may not be directly executable by the at least one processor 640 but may cause a computer (e.g., when compiled and executed) to perform functions described herein. In some cases, the at least one memory 630 may include, among other things, a basic I/O system (BIOS) which may control basic hardware or software operation such as the interaction with peripheral components or devices.

The at least one processor 640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 640 may be configured to operate a memory array using a memory controller. In some other cases, a memory controller may be integrated into the at least one processor 640. The at least one processor 640 may be configured to execute computer-readable instructions stored in a memory (e.g., the at least one memory 630) to cause the device 605 to perform various functions (e.g., functions or tasks supporting resolving collisions with LP-WUSs in SBFD resources). For example, the device 605 or a component of the device 605 may include at least one processor 640 and at least one memory 630 coupled with or to the at least one processor 640, the at least one processor 640 and the at least one memory 630 configured to perform various functions described herein.

In some examples, the at least one processor 640 may include multiple processors and the at least one memory 630 may include multiple memories. One or more of the multiple processors may be coupled with one or more of the multiple memories, which may, individually or collectively, be configured to perform various functions described herein. In some examples, the at least one processor 640 may be a component of a processing system, which may refer to a system (such as a series) of machines, circuitry (including, for example, one or both of processor circuitry (which may include the at least one processor 640) and memory circuitry (which may include the at least one memory 630)), or components, that receives or obtains inputs and processes the inputs to produce, generate, or obtain a set of outputs. The processing system may be configured to perform one or more of the functions described herein. For example, the at least one processor 640 or a processing system including the at least one processor 640 may be configured to, configurable to, or operable to cause the device 605 to perform one or more of the functions described herein. Further, as described herein, being “configured to,” being “configurable to,” and being “operable to” may be used interchangeably and may be associated with a capability, when executing code 635 (e.g., processor-executable code) stored in the at least one memory 630 or otherwise, to perform one or more of the functions described herein.

The communications manager 620 may support wireless communications in accordance with examples as disclosed herein. For example, the communications manager 620 is capable of, configured to, or operable to support a means for receiving first configuration information that indicates a SBFD resource that includes one or more uplink resources and one or more downlink resources that overlap in time with the one or more uplink resources. The communications manager 620 is capable of, configured to, or operable to support a means for receiving second configuration information that schedules a LP-WUS during the one or more downlink resources of the SBFD resource. The communications manager 620 is capable of, configured to, or operable to support a means for receiving third configuration information that schedules an uplink transmission during the one or more uplink resources of the SBFD resource. The communications manager 620 is capable of, configured to, or operable to support a means for participating in communications with one or both of the LP-WUS and the uplink transmission during the SBFD resource in accordance with one or more prioritization rules.

By including or configuring the communications manager 620 in accordance with examples as described herein, the device 605 may support techniques for determining prioritization for LP-WUSs and uplink transmissions for SBFD-aware UEs, which may result in improved communication reliability, reduced latency, reduced power consumption, more efficient utilization of communication resources, improved coordination between devices, and longer battery life.

In some examples, the communications manager 620 may be configured to perform various operations (e.g., receiving, monitoring, transmitting) using or otherwise in cooperation with the transceiver 615, the one or more antennas 625, or any combination thereof. Although the communications manager 620 is illustrated as a separate component, in some examples, one or more functions described with reference to the communications manager 620 may be supported by or performed by the at least one processor 640, the at least one memory 630, the code 635, or any combination thereof. For example, the code 635 may include instructions executable by the at least one processor 640 to cause the device 605 to perform various aspects of resolving collisions with LP-WUSs in SBFD resources as described herein, or the at least one processor 640 and the at least one memory 630 may be otherwise configured to, individually or collectively, perform or support such operations.

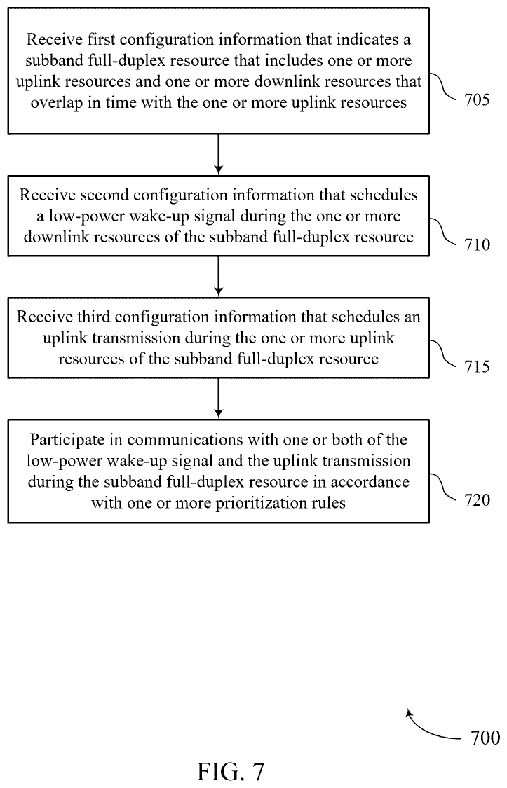

FIG. 7 shows a flowchart illustrating a method 700 that supports resolving collisions with LP-WUSs in SBFD resources in accordance with one or more aspects of the present disclosure. The operations of the method 700 may be implemented by a UE or its components as described herein. For example, the operations of the method 700 may be performed by a UE 115 as described with reference to FIGS. 1 through 6. In some examples, a UE may execute a set of instructions to control the functional elements of the UE to perform the described functions. Additionally, or alternatively, the UE may perform aspects of the described functions using special-purpose hardware.

At 705, the method may include receiving first configuration information that indicates a SBFD resource that includes one or more uplink resources and one or more downlink resources that overlap in time with the one or more uplink resources. The operations of 705 may be performed in accordance with examples as disclosed herein. In some examples, aspects of the operations of 705 may be performed by an SBFD resource component 525 as described with reference to FIG. 5.

At 710, the method may include receiving second configuration information that schedules a LP-WUS during the one or more downlink resources of the SBFD resource. The operations of 710 may be performed in accordance with examples as disclosed herein. In some examples, aspects of the operations of 710 may be performed by an LP-WUS configuration component 530 as described with reference to FIG. 5.

At 715, the method may include receiving third configuration information that schedules an uplink transmission during the one or more uplink resources of the SBFD resource. The operations of 715 may be performed in accordance with examples as disclosed herein. In some examples, aspects of the operations of 715 may be performed by an uplink transmission configuration component 535 as described with reference to FIG. 5.

At 720, the method may include participating in communications with one or both of the LP-WUS and the uplink transmission during the SBFD resource in accordance with one or more prioritization rules. The operations of 720 may be performed in accordance with examples as disclosed herein. In some examples, aspects of the operations of 720 may be performed by a priority rule component 540 as described with reference to FIG. 5.

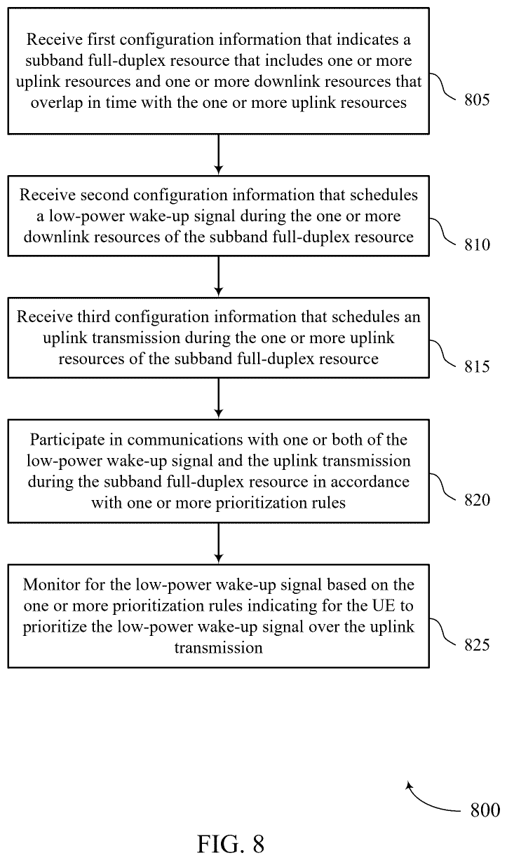

FIG. 8 shows a flowchart illustrating a method 800 that supports resolving collisions with LP-WUSs in SBFD resources in accordance with one or more aspects of the present disclosure. The operations of the method 800 may be implemented by a UE or its components as described herein. For example, the operations of the method 800 may be performed by a UE 115 as described with reference to FIGS. 1 through 6. In some examples, a UE may execute a set of instructions to control the functional elements of the UE to perform the described functions. Additionally, or alternatively, the UE may perform aspects of the described functions using special-purpose hardware.

At 805, the method may include receiving first configuration information that indicates a SBFD resource that includes one or more uplink resources and one or more downlink resources that overlap in time with the one or more uplink resources. The operations of 805 may be performed in accordance with examples as disclosed herein. In some examples, aspects of the operations of 805 may be performed by an SBFD resource component 525 as described with reference to FIG. 5.

At 810, the method may include receiving second configuration information that schedules a LP-WUS during the one or more downlink resources of the SBFD resource. The operations of 810 may be performed in accordance with examples as disclosed herein. In some examples, aspects of the operations of 810 may be performed by an LP-WUS configuration component 530 as described with reference to FIG. 5.

At 815, the method may include receiving third configuration information that schedules an uplink transmission during the one or more uplink resources of the SBFD resource. The operations of 815 may be performed in accordance with examples as disclosed herein. In some examples, aspects of the operations of 815 may be performed by an uplink transmission configuration component 535 as described with reference to FIG. 5.

At 820, the method may include participating in communications with one or both of the LP-WUS and the uplink transmission during the SBFD resource in accordance with one or more prioritization rules. The operations of 820 may be performed in accordance with examples as disclosed herein. In some examples, aspects of the operations of 820 may be performed by a priority rule component 540 as described with reference to FIG. 5.

At 825, the method may include monitoring for the LP-WUS based on the one or more prioritization rules indicating for the UE to prioritize the LP-WUS over the uplink transmission. The operations of 825 may be performed in accordance with examples as disclosed herein. In some examples, aspects of the operations of 825 may be performed by a priority rule component 540 as described with reference to FIG. 5.

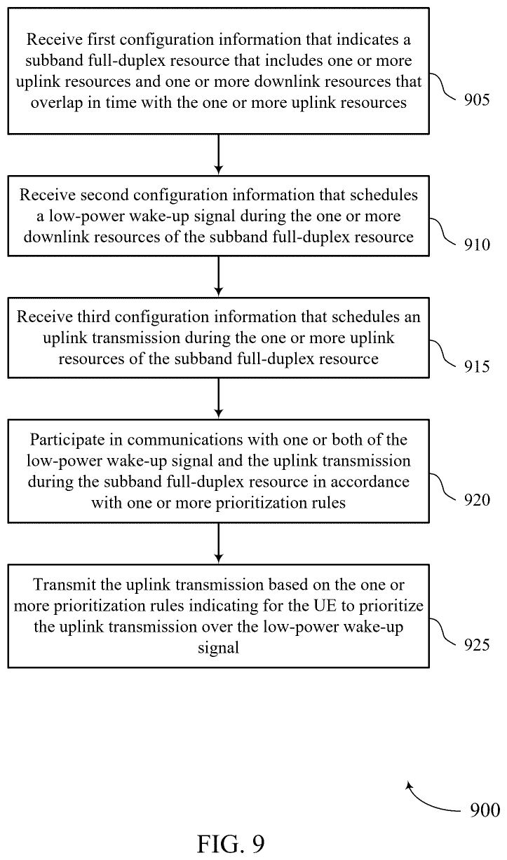

FIG. 9 shows a flowchart illustrating a method 900 that supports resolving collisions with LP-WUSs in SBFD resources in accordance with one or more aspects of the present disclosure. The operations of the method 900 may be implemented by a UE or its components as described herein. For example, the operations of the method 900 may be performed by a UE 115 as described with reference to FIGS. 1 through 6. In some examples, a UE may execute a set of instructions to control the functional elements of the UE to perform the described functions. Additionally, or alternatively, the UE may perform aspects of the described functions using special-purpose hardware.

At 905, the method may include receiving first configuration information that indicates a SBFD resource that includes one or more uplink resources and one or more downlink resources that overlap in time with the one or more uplink resources. The operations of 905 may be performed in accordance with examples as disclosed herein. In some examples, aspects of the operations of 905 may be performed by an SBFD resource component 525 as described with reference to FIG. 5.

At 910, the method may include receiving second configuration information that schedules a LP-WUS during the one or more downlink resources of the SBFD resource. The operations of 910 may be performed in accordance with examples as disclosed herein. In some examples, aspects of the operations of 910 may be performed by an LP-WUS configuration component 530 as described with reference to FIG. 5.

At 915, the method may include receiving third configuration information that schedules an uplink transmission during the one or more uplink resources of the SBFD resource. The operations of 915 may be performed in accordance with examples as disclosed herein. In some examples, aspects of the operations of 915 may be performed by an uplink transmission configuration component 535 as described with reference to FIG. 5.

At 920, the method may include participating in communications with one or both of the LP-WUS and the uplink transmission during the SBFD resource in accordance with one or more prioritization rules. The operations of 920 may be performed in accordance with examples as disclosed herein. In some examples, aspects of the operations of 920 may be performed by a priority rule component 540 as described with reference to FIG. 5.

At 925, the method may include transmitting the uplink transmission based on the one or more prioritization rules indicating for the UE to prioritize the uplink transmission over the LP-WUS. The operations of 925 may be performed in accordance with examples as disclosed herein. In some examples, aspects of the operations of 925 may be performed by a priority rule component 540 as described with reference to FIG. 5.

The following provides an overview of aspects of the present disclosure:

Aspect 1: A method for wireless communications by a UE, comprising: receiving first configuration information that indicates a SBFD resource that includes one or more uplink resources and one or more downlink resources that overlap in time with the one or more uplink resources; receiving second configuration information that schedules a LP-WUS during the one or more downlink resources of the SBFD resource; receiving third configuration information that schedules an uplink transmission during the one or more uplink resources of the SBFD resource; and participating in communications with one or both of the LP-WUS and the uplink transmission during the SBFD resource in accordance with one or more prioritization rules.

Aspect 2: The method of aspect 1, wherein participating in the communications comprises: monitoring for the LP-WUS based at least in part on the one or more prioritization rules indicating for the UE to prioritize the LP-WUS over the uplink transmission.

Aspect 3: The method of aspect 2, wherein the LP-WUS is dynamically activated, the method further comprising: canceling the uplink transmission in accordance with the one or more prioritization rules indicating for the UE to cancel the uplink transmission based at least in part on a difference between a first time at which the UE receives the second configuration information and a second time at which the UE is scheduled to transmit the uplink transmission being greater than a threshold time.

Aspect 4: The method of aspect 1, wherein participating in the communications comprises: transmitting the uplink transmission based at least in part on the one or more prioritization rules indicating for the UE to prioritize the uplink transmission over the LP-WUS.

Aspect 5: The method of aspect 4, wherein transmitting the uplink transmission comprises: transmitting the uplink transmission via a logical channel, wherein the one or more prioritization rules indicate for the UE to prioritize the uplink transmission over the LP-WUS based at least in part on a priority of the logical channel.

Aspect 6: The method of any of aspects 4 through 5, wherein the LP-WUS is dynamically activated, the one or more prioritization rules indicate for the UE to transmit the uplink transmission based at least in part on a difference between a first time at which the UE receives the second configuration information and a second time at which the UE is scheduled to transmit the uplink transmission being less than a threshold time.

Aspect 7: The method of any of aspects 1 through 6, wherein participating in the communications comprises: transmitting the uplink transmission via a main radio of the UE; and monitoring for the LP-WUS via a LP-WUR of the UE, wherein the one or more prioritization rules indicate for the UE to transmit the uplink transmission and monitor for the LP-WUS based at least in part on the main radio being separate from the LP-WUR.

Aspect 8: The method of any of aspects 3 through 7, further comprising: receiving fourth configuration information indicating a change in a schedule associated with the LP-WUS, wherein participating in the communications comprises: transmitting the uplink transmission based at least in part on the change in the schedule associated with the LP-WUS.

Aspect 9: The method of any of aspects 1 through 8, further comprising: receiving a control signal indicating the one or more prioritization rules.

Aspect 10: The method of any of aspects 1 through 9, wherein the uplink transmission comprises a PUSCH message, a PUCCH message, a HARQ feedback message, a scheduling request, or an SRS.

Aspect 11: A UE for wireless communications, comprising one or more memories storing processor-executable code, and one or more processors coupled with the one or more memories and individually or collectively operable to execute the code to cause the UE to perform a method of any of aspects 1 through 10.

Aspect 12: A UE for wireless communications, comprising at least one means for performing a method of any of aspects 1 through 10.

Aspect 13: A non-transitory computer-readable medium storing code for wireless communications, the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first configuration information that indicates a subband full-duplex resource that includes one or more uplink resources and one or more downlink resources that overlap in time with the one or more uplink resources;
receive second configuration information that schedules a low-power wake-up signal during the one or more downlink resources of the subband full-duplex resource;
receive third configuration information that schedules an uplink transmission during the one or more uplink resources of the subband full-duplex resource; and
participate in communications with one or both of the low-power wake-up signal and the uplink transmission during the subband full-duplex resource in accordance with one or more prioritization rules.

2. The UE of claim 1, wherein, to participate in the communications, the one or more processors are individually or collectively operable to execute the code to cause the UE to:
monitor for the low-power wake-up signal based at least in part on the one or more prioritization rules indicating for the UE to prioritize the low-power wake-up signal over the uplink transmission.

3. The UE of claim 2, wherein the low-power wake-up signal is dynamically activated, and the one or more processors are individually or collectively further operable to execute the code to cause the UE to:
cancel the uplink transmission in accordance with the one or more prioritization rules indicating for the UE to cancel the uplink transmission based at least in part on a difference between a first time at which the UE receives the second configuration information and a second time at which the UE is scheduled to transmit the uplink transmission being greater than a threshold time.

4. The UE of claim 1, wherein, to participate in the communications, the one or more processors are individually or collectively operable to execute the code to cause the UE to:
transmit the uplink transmission based at least in part on the one or more prioritization rules indicating for the UE to prioritize the uplink transmission over the low-power wake-up signal.

5. The UE of claim 4, wherein, to transmit the uplink transmission, the one or more processors are individually or collectively operable to execute the code to cause the UE to:
transmit the uplink transmission via a logical channel, the one or more prioritization rules indicate for the UE to prioritize the uplink transmission over the low-power wake-up signal based at least in part on a priority of the logical channel.

6. The UE of claim 4, wherein the low-power wake-up signal is dynamically activated, and wherein the one or more prioritization rules indicate for the UE to transmit the uplink transmission based at least in part on a difference between a first time at which the UE receives the second configuration information and a second time at which the UE is scheduled to transmit the uplink transmission being less than a threshold time.

7. The UE of claim 1, wherein, to participate in the communications, the one or more processors are individually or collectively operable to execute the code to cause the UE to:
transmit the uplink transmission via a main radio of the UE; and
monitor for the low-power wake-up signal via a low-power wake-up radio of the UE, wherein the one or more prioritization rules indicate for the UE to transmit the uplink transmission and monitor for the low-power wake-up signal based at least in part on the main radio being separate from the low-power wake-up radio.

8. The UE of claim 1, wherein the one or more processors are individually or collectively further operable to execute the code to cause the UE to:
receive fourth configuration information indicating a change in a schedule associated with the low-power wake-up signal, wherein, to participate in the communications, the one or more processors are individually or collectively further operable to cause the UE to:
transmit the uplink transmission based at least in part on the change in the schedule associated with the low-power wake-up signal.

9. The UE of claim 1, wherein the one or more processors are individually or collectively further operable to execute the code to cause the UE to:
receive a control signal indicating the one or more prioritization rules.

10. The UE of claim 1, wherein the uplink transmission comprises a physical uplink shared channel message, a physical uplink control channel message, a hybrid automatic repeat request feedback message, a scheduling request, or a sounding reference signal.

11. A method for wireless communications by a user equipment (UE), comprising:
receiving first configuration information that indicates a subband full-duplex resource that includes one or more uplink resources and one or more downlink resources that overlap in time with the one or more uplink resources;
receiving second configuration information that schedules a low-power wake-up signal during the one or more downlink resources of the subband full-duplex resource;
receiving third configuration information that schedules an uplink transmission during the one or more uplink resources of the subband full-duplex resource; and
participating in communications with one or both of the low-power wake-up signal and the uplink transmission during the subband full-duplex resource in accordance with one or more prioritization rules.

12. The method of claim 11, wherein participating in the communications comprises:
monitoring for the low-power wake-up signal based at least in part on the one or more prioritization rules indicating for the UE to prioritize the low-power wake-up signal over the uplink transmission.

13. The method of claim 12, wherein the low-power wake-up signal is dynamically activated, the method further comprising:
canceling the uplink transmission in accordance with the one or more prioritization rules indicating for the UE to cancel the uplink transmission based at least in part on a difference between a first time at which the UE receives the second configuration information and a second time at which the UE is scheduled to transmit the uplink transmission being greater than a threshold time.

14. The method of claim 11, wherein participating in the communications comprises:
transmitting the uplink transmission based at least in part on the one or more prioritization rules indicating for the UE to prioritize the uplink transmission over the low-power wake-up signal.

15. The method of claim 14, wherein transmitting the uplink transmission comprises:
transmitting the uplink transmission via a logical channel, the one or more prioritization rules indicate for the UE to prioritize the uplink transmission over the low-power wake-up signal based at least in part on a priority of the logical channel.

16. The method of claim 14, wherein the low-power wake-up signal is dynamically activated, and wherein the one or more prioritization rules indicate for the UE to transmit the uplink transmission based at least in part on a difference between a first time at which the UE receives the second configuration information and a second time at which the UE is scheduled to transmit the uplink transmission being less than a threshold time.

17. The method of claim 11, wherein participating in the communications comprises:
transmitting the uplink transmission via a main radio of the UE; and
monitoring for the low-power wake-up signal via a low-power wake-up radio of the UE, wherein the one or more prioritization rules indicate for the UE to transmit the uplink transmission and monitor for the low-power wake-up signal based at least in part on the main radio being separate from the low-power wake-up radio.

18. The method of claim 11, further comprising:
receiving fourth configuration information indicating a change in a schedule associated with the low-power wake-up signal, wherein participating in the communications comprises:
transmitting the uplink transmission based at least in part on the change in the schedule associated with the low-power wake-up signal.

19. The method of claim 11, further comprising:
receiving a control signal indicating the one or more prioritization rules.

20. A non-transitory computer-readable medium storing code for wireless communications, the code comprising instructions executable by one or more processors to:
receive first configuration information that indicates a subband full-duplex resource that includes one or more uplink resources and one or more downlink resources that overlap in time with the one or more uplink resources;
receive second configuration information that schedules a low-power wake-up signal during the one or more downlink resources of the subband full-duplex resource;
receive third configuration information that schedules an uplink transmission during the one or more uplink resources of the subband full-duplex resource; and
participate in communications with one or both of the low-power wake-up signal and the uplink transmission during the subband full-duplex resource in accordance with one or more prioritization rules.
